(19) United States
(12) Patent Application Publication
(10) Pub. No.: US 2016/0202845 A1
(43) Pub. Date: Jul. 14, 2016

(54) Shared Graphical Workspace

(71) Applicant: Homework Alliance LLC, College Station, TX (US)

(72) Inventors: Christopher Joseph Findeisen, Bryan, TX (US); Maksim Tsepkov, Ekaterinburg (RU)

(73) Assignee: Homework Alliance LLC, College Station, TX (US)

(21) Appl. No.: 14/874,094

(22) Filed: Oct. 2, 2015

Related U.S. Application Data
(60) Provisional application No. 62/058,999, filed on Oct. 2, 2014.

(51) Int. Cl. G06F 3/0481; H04L 29/06

(52) U.S. Cl. CPC G06F 3/0481; H04L 67/42

(57) ABSTRACT

A method for transferring data on a graphical workspace. The graphical workspace may keep a bi-directional line of communication open between a server and user's browser, allowing for the free movement of data from the server to the user. Data may be transferred between the server and user using a single-command and/or a batch-command. The graphical workspace may be updated as soon as commands are received by either a user and/or client, which may allow for an instantaneous movement of information across the graphical workspace while using less data.

### CROSS-REFERENCE TO RELATED APPLICATIONS

The present application claims priority to U.S. Provisional Application No. 62/058,999, filed on Oct. 2, 2014, the entire disclosure of which is incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present embodiments relate to a method for a real-time collaborative shared graphical workspace, and more particularly, a real-time collaborative method for multiple clients to collaborate on a shared graphical workspace, expedited by only sharing changes made. The method eliminates need for requests for updates or triggering employed by other methods.

2. BACKGROUND OF THE INVENTION

A typical method of operating a shared graphical workspace requires the transfer of a vast amount of Scalable Vector Graphic data. The large transfer of data requires large amounts of bandwidth, clogging networks and overloading servers. Clogged networks and overloaded servers lead to latency issues, slower transfer rates, servers timing out, and potential server crashes.

Latency issues and slower transfer rates make interaction between clients over a shared graphical workspace difficult. Clients may experience difficulty in adding data to the graphical workspace and receiving data from the graphical workspace. Furthermore, making the experience shared graphical workspace slow and unreliable tends to keep potential clients from using the shared graphical workspace and seek other forms of communication.

Consequently, there is a need for a method that uses small amounts of data to operate a shared graphical workspace with multiple clients. Allowing individuals to communicate ideas and thoughts freely, without the difficulty experienced by current shared graphical workspace methods.

### BRIEF SUMMARY OF SOME OF THE PREFERRED EMBODIMENTS

These and other needs in the art are addressed in one embodiment by transferring data in a shared graphical workspace method. The method may comprise accessing a graphical workspace on a media device, which may further comprise an interface. Additionally, the method may further comprise changing the interface, which may be accomplished by a change in a command. The method may further comprise sending the command to a server and executing the command on the media device, saving the command on the server, and sending the command to a plurality of clients.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will be made to the accompanying drawings in which:

FIG. 1 illustrates the graphical workspace method used to change, manipulate, or alter the whiteboard interface; and

FIG. 2 illustrates the graphical workspace method for updating a user connecting to a server after logged commands have been entered on the server.

### DETAILED DESCRIPTION OF THE PREFERRED EMBODIMENTS

The graphical workspace method provides an environment for individuals to communicate ideas and thoughts to others. In embodiments, the graphical workspace method may be used for the exchange of information in educational and business settings. For example, the graphical workspace method may be used to set up a “classroom”, where students may be able to log in and discuss homework, assignments. test, or the like using a whiteboard interface. In embodiments. the graphical workspace interface may run on a server. The server running the graphical workspace interface may be characterized as a “cloud server”. A user may access the workspace interface through any media device that may be capable of accessing the internet. Such device may include a computer, notebook, cell phone, laptop, and the like.

A user, using a media device, may access the graphical workspace interface through a browser. Any browser, for example Google Chrome or Firefox, may access the server and operate the graphical workspace. The browser may use HTML, specifically HTML 5 and/or higher, computer language to access the graphical workspace. This may be beneficial method of operation because there may be no need for users to download software to their media device. This may save space and improve performance of the user's media device.

In embodiments. the graphical workspace may be used on closed networks, open networks, Wi-Fi networks, cable networks. virtual networks, telephone networks, and/or the like. Still further, the graphical workspace may be distributed as software application. The software may be downloaded from a third party server and/or uploaded from a peripheral device such as a CD, USB, or other mass storage device.

Whether accessing the graphical workspace through a browser and/or using software, the graphical workspace interface presents the user with a variety of prompts when accessed. Prompts may include, “Start a New Session” and/or “Resume Previous Session”. Selecting “Start a New Session” allows the user to set up a workspace, room, and/or whiteboard, all of which may be referred to as a “classroom,” for others to join. The user may have the option to fill in fields that may name the “classroom” and add any information that may be need to identify the “classroom” for others. To join a “classroom” that has been set up, a user may send “invitations” for others to join. When a client receives the “invitation,” the client may select a hyperlink that may route them to the “classroom.” Other means of joining may involve the clients accessing the graphical workspace interface and joining the setup “classroom”. A user may setup the “classroom” as public or private. A public “classroom” may allow anyone to join and a private “classroom” may require access codes, passwords. encryption, or the like to join the “classroom.” There may be any number of clients that may join the user's created “classroom.”

The graphical workspace uses a graphical user interface comprising a whiteboard with a set of prompts and buttons that perform functions on the graphical user interface. Each button and prompt produces different commands. Commands alter the whiteboard, which alters the interface based upon the command received by the whiteboard. Pen, mouse, motion, and/or touch technology may be used to alter the interface, as well. Current embodiments that use a whiteboard interface require the transfer of vast amounts of Scalable Vector Graphic data, which may be inherently slow.

In embodiments, the disclosed graphical workspace method may increase operability with the use of a set of commands and transfer methods. A transfer method may be websockets as the medium and commands may act as information. The result of this method may be a fast transfer of information which may update using localized changes. Websockets allow the method to update a client, without the client requesting an update.

Websockets are a web protocol providing full-duplex communications channels over a single TCP connection. It provides a way for the server to send content to the browser without being solicited by the client, and allowing for messages to be passed back and forth while keeping the connection open. This creates a two-way (bi-directional) ongoing conversation between a browser and a server.

Using websockets saves bandwidth by never sending information if changes have not occurred on the graphical workspace. This keeps the graphical workspace from constantly sending full Scalable Vector Graphic data, which significantly affects performance. In other embodiments, the graphical workspace method may use any form of HTP Request and/or data transfer system, besides using Websockets. The graphical workspace transfers changes and updates to the whiteboard between clients using a set of commands.

Commands consist of individual lines of data that are sent to the server, allowing the whiteboard program to re-create a single change. This may take place without a need for any additional information from the media device about the state of the whiteboard interface. This type of a “command” ensures that the whiteboard state may be reproduced, regardless of when a client joins. This also eliminates the need to repeatedly send a pixel and/or data driven copy of the interface. which may comprise large amounts of data. All data may be transferred in two commands: a single-command that updates the whiteboard to a specific action and a batch-command, which may be a series of specific single-commands that are logged as a single transfer action. The batch-command may allow all previous commands to be executed in a single action, but also removes all the commands if the batch-command may be removed. which ensures that anything done may be un-done by reversing the command. An example of this is “ImportPDFCommand,” which converts a file, creates layers and generates the content for the layers. This command may contain three distinct commands, if a user undoes this command, all three contained commands will be reversed. The executed commands may be generated on the whiteboard and a server may distribute the commands using graphical workspace transfer methods.

When a user joins a session, they load a client-side whiteboard program that handles and processes any local actions. This whiteboard program translates all whiteboard interaction into executable commands and may also processes executable commands. After the whiteboard program loads, the client may be connected to a server using a unique ID that corresponds to the room. The client then sends a request for any commands that may have been logged prior to joining. The server checks for logged commands, and if none may be found, a simple echo may be given without any commands. If there are logged commands, they're sent to the client. They are executed in order, reproducing all of the actions that have been made previously to the client joining. If any other clients join the same room, they're given the same room ID and the loading process would be the same. When a client joins a “classroom,” the server will update on the clients mobile device. A change may be administered by a client and/or user, the change may be recorded and logged in the server. The change, a series of commands, may be filtered to the other clients logged into the “classroom,” changing each client's interface to reflect the change.

If a user makes any changes to the whiteboard, the change may be logged as a command by the whiteboard program. This command corresponds to a specific action, and contains enough information to reproduce the change on additional clients. This command may be first added to the history manager of the user and then sent to the server. The user's whiteboard program may then execute the command. When the server receives the command, it may first save the command under a log of commands. and then echoes the log of commands to clients that may be currently connected to that hub server with the same room ID. The client's media device may execute this command, but the commands may not be logged into their history manager. These steps may be performed by a user and/or client, changing the whiteboard for the user and any additional clients. This may allow both the clients and user to manipulate the whiteboard. However, in some embodiments the user may create a “classroom” that may only allow the user to change the whiteboard. clients may not be able to change and/or manipulate the whiteboard.

During the session, all commands may be saved and stored on the server. These commands may be stored as single-commands and/or in batch-commands. The storing of data may allow the user and clients to leave the “classroom” and re-join the “classroom” without losing data. Accessing saved data, by users and/or clients, sends the saved data in a batch-command, or multiple single-commands, replicating the whiteboard as it was before the user and clients left the “classroom”. After a user and client have completed their “classroom” session, which may span any number of days, the user may select a prompt that removes the session from the server. For example, the prompt may say “Remove Session”, which would remove all saved data from the server.

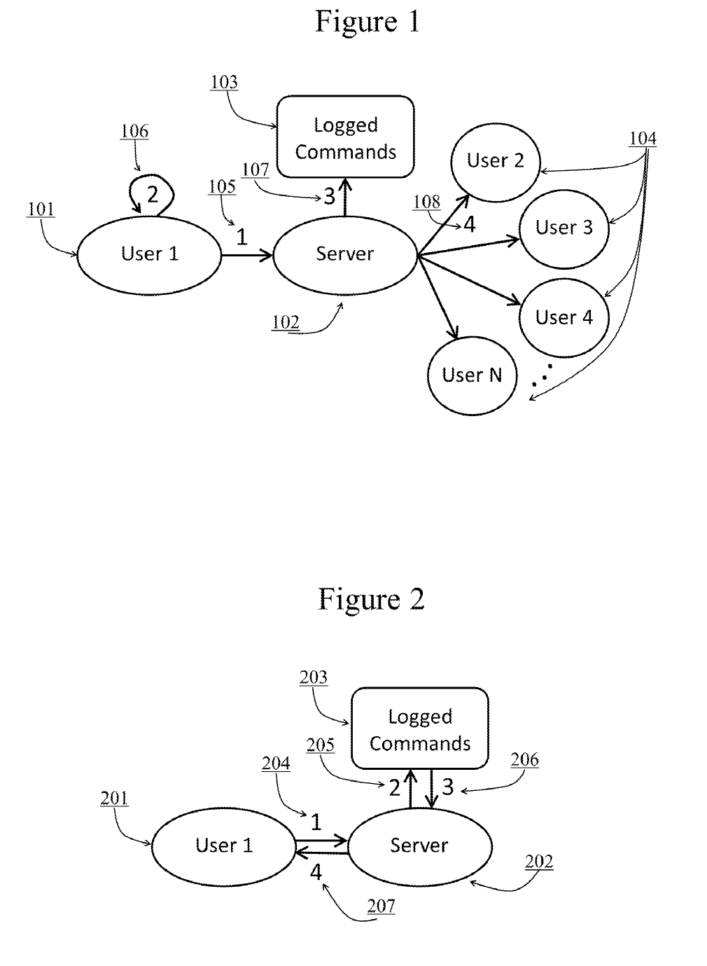

FIG. 1 illustrates the graphical workspace method used to change, manipulate, and/or alter the whiteboard interface. Step 1 illustrates the flow of information when a user [101] changes, manipulates, or alters their whiteboard interface. The whiteboard interface processes it as a single command and sends it [105] to the server [102]. The whiteboard then executes the command locally on the users interface in Step 2 [106]. The command is received by the server, which logs and stores the command in Step 3 [107] in logged commands [103]. The server, in Step 4 [108], then sends the command to all of the other connected users [104].

Illustrated in FIG. 2, the graphical workspace method may be used to update a user [201] who connects to a server after logged commands have already been entered on the server. In Step 1, the user connects [204] to the server [202]. The server, in Step 2, checks [205] if there are any already logged commands [203]. If there are logged commands, the server accesses them in Step 3 [206]. The server sends the logged commands as a batch-command in Step 4 [207]. In further explanation of Step 4, note that no request may be made, rather the server pushes the batch-command to the client. The batch-command executes all logged commands, in order, on a connecting client's media device. The client's whiteboard may be updated with the commands in order to reproduce the current state of the whiteboard.

What is claimed is:

1. A method for transferring data in a shared graphical workspace comprising:
(A) accessing a graphical workspace on a media device, wherein the graphical workspace has an interface;
(B) changing the interface, wherein the graphical workspace processes only the change as a command;
(C) executing the command on the media device;
(D) sending the command to a server;
(E) saving the command on the server;
(F) sending the command to a plurality of clients.

2. The method of claim 1, wherein the media device consists of a client computer in the form of a stationary device.

3. The method of claim 1, wherein the media device consists of a client computer in the form of a mobile device.

4. The method of claim 1, wherein the changing the interface consists of a user manipulating the interface using a finger, stylus, pen, touchpad, mouse, motion, or combination.

5. The method of claim 1, wherein the executing the command consists of a batch of individual commands.

6. The method of claim 1, wherein sending the command is executed using websockets.

7. The method of claim 1, wherein sending the command to a plurality of clients is followed by the execution of the command to the client interface.

8. A method for transferring data in a shared graphical workspace comprising:
(A) accessing a graphical workspace on a media device, wherein the graphical workspace has an interactive interface;
(B) changing the interactive interface through the use of an input device, wherein the graphical workspace processes the change as a command;
(C) executing the command on the media device to alter the interactive interface;
(D) sending the command to a server;
(E) saving the command on the server;
(F) sending the command to a plurality of clients;
(G) executing the command to alter a client interface in the same manner as the original interactive interface.

9. The method of claim 8, wherein the media device consists of a client computer in the form of a stationary device.

10. The method of claim 8, wherein the media device consists of a client computer in the form of a mobile device.

11. The method of claim 8, wherein the changing the interface consists of a user manipulating the interactive interface using a finger, stylus, pen, touchpad, mouse, motion, or combination.

12. The method of claim 8, wherein the executing the command consists of a batch of individual commands.

13. The method of claim 8, wherein sending the command is executed using websockets.

14. A method for transferring data in a shared graphical workspace comprising:
(A) accessing a graphical workspace on a computing device, wherein the graphical workspace has an interactive interface;
(B) changing the interactive interface through the use of an input device, wherein the graphical workspace processes only the change as a command;
(C) executing the command on the media device to alter the interactive interface;
(D) sending the command to a server;
(E) saving the command on the server;
(F) collecting a plurality of commands as a set of commands;
(G) sending the set of commands to a plurality of clients;
(H) executing the set of commands to alter a client interface in the same manner as the original interactive interface.

15. The method of claim 14, wherein the changing the interface consists of a user manipulating the interactive interface using a finger, stylus, pen, touchpad, mouse, motion, or combination.

16. The method of claim 14, wherein sending the commands is executed using websockets.
